(19) United States
(12) Patent Application Publication
(10) Pub. No.: US 2026/0039341 A1
(43) Pub. Date: Feb. 5, 2026

(54) IMPLEMENTING DISTRIBUTED COMPUTATION FOR PRECODING IN MU-MIMO

(71) Applicant: Samsung Electronics Co., Ltd., Suwon-si (KR)

(72) Inventors: Pranav Madadi, Sunnyvale, CA (US); Mandar Kulkarni, Bridgewater, NJ (US); Yeqing Hu, Allen, TX (US); Tiexing Wang, Melissa, TX (US); Yan Xin, Princeton, NJ (US); Yang Li, Plano, TX (US); Jianzhong Zhang, Dallas, TX (US)

(21) Appl. No.: 19/077,015

(22) Filed: Mar. 11, 2025

Related U.S. Application Data
(60) Provisional application No. 63/677,826, filed on Jul. 31, 2024.

(51) Int. Cl. H04B 7/0456

(52) U.S. Cl. CPC H04B 7/0456

(57) ABSTRACT

Distributed precoding computation involves receiving, from UEs served by the base station, UE precoding capability information for UE support of distributed iterative precoding computation or distributed artificial intelligence (AI)-based precoding computation. A precoding computation scheme is determined based on the UE precoding capability information and UE characteristics. Results of local precoding computations by each of the UEs are employed in determining precoders for the UEs. Distributed precoding computation parameters are transmitted to the UEs. The parameters may enable/disable distributed precoding computation, identify a precoding algorithm, or indicate a number of iterations or a maximum iteration time for precoding computation, and the results of local precoding computations may include an updated result after a specific iteration. For a transformer-based distributed precoding computation algorithm, the distributed precoding computation parameters may indicate trained neural network parameters and the results of local precoding computations may include an output of a neural network encoder.

### CROSS-REFERENCE TO RELATED AND CLAIM OF PRIORITY

The present application claims priority under 35 U.S.C. § 119 (e) to U.S. Provisional Patent Application No. 63/677,826 filed on Jul. 31, 2024, which is hereby incorporated by reference in its entirety.

### TECHNICAL FIELD

The present disclosure relates generally to precoding in wireless communications systems and, more specifically, to distributed computation for such precoding.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to distributed precoding computation.

In a first embodiment, a method performed by a base station for distributed precoding computation includes receiving, from a plurality of user equipments (UEs) served by the base station, UE precoding capability information for support by one or more of the plurality of UEs for at least one of distributed iterative precoding computation or distributed artificial intelligence (AI)-based precoding computation. The method also includes determining a precoding computation scheme based on at least the UE precoding capability information and characteristics of the plurality of UEs served by the base station. The method further includes receiving a result of local precoding computations by each of the one or more of the plurality of UEs. The method still further includes determining precoders for the plurality of UEs based at least in part on the result of the local precoding computations. The method includes transmitting distributed precoding computation parameters to the one or more of the plurality of UEs.

Any single one or any combination of the following features may be used with the first embodiment. The UE precoding capability information may be received by one of: an uplink control information (UCI) in a physical uplink control channel (PUCCH), or a medium access control (MAC) control element (CE) identified by a MAC protocol data unit (PDU) in a physical uplink shared channel (PUSCH). The precoding computation scheme is determined based on at least one of: a number of negative acknowledgements (NACKs) received from the plurality of UEs, channel state information indicating ill-conditioned channels between the base station and the plurality of UEs, or proximity of a number of the plurality of UEs. The distributed precoding computation parameters may be transmitted in one of: a radio resource control (RRC) message for configuration of a physical downlink shared channel (PDSCH), or a downlink control information (DCI) message on a physical downlink control channel (PDCCH). The distributed precoding computation parameters include at least one of: a parameter enabling/disabling distributed precoding computation; a parameter identifying a distributed precoding computation algorithm to be used for the precoding computation scheme; a number of iterations for the distributed precoding computation; or a maximum iteration time for the distributed precoding computation. The precoding computation scheme may also be determined based on at least one of: channel state information feedback from the plurality of UEs, or uplink reference signals transmitted by the plurality of UEs. The result of the local precoding computations may include an updated result after a specific iteration of a distributed precoding computation algorithm used for the precoding computation scheme. Precoders for the plurality of UEs may be determined by selecting a transformer-based precoding computation algorithm. The distributed precoding computation parameters that are transmitted may indicate trained neural network parameters for the transformer-based precoding computation algorithm. The result of the local precoding computations comprises: an output of a neural network encoder at each of the one or more of the plurality of UEs.

In a second embodiment, a base station for distributed precoding computation includes a transceiver configured to receive, from a plurality of user equipments (UEs) served by the base station, UE precoding capability information for support by one or more of the plurality of UEs for at least one of distributed iterative precoding computation or distributed artificial intelligence (AI)-based precoding computation. The base station also includes at least one processing device coupled to the transceiver and configured to determine a precoding computation scheme based on at least the UE precoding capability information and characteristics of the plurality of UEs served by the base station. The at least one processing device is also configured to receive a result of local precoding computations by each of the one or more of the plurality of UEs. The at least one processing device is also configured to determine precoders for the plurality of UEs based at least in part on the result of the local precoding computations. The at least one processing device is also configured to transmit distributed precoding computation parameters to the one or more of the plurality of UEs.

Any single one or any combination of the following features may be used with the second embodiment. The UE precoding capability information may be received by one of: an uplink control information (UCI) in a physical uplink control channel (PUCCH), or a medium access control (MAC) control element (CE) identified by a MAC protocol data unit (PDU) in a physical uplink shared channel (PUSCH). The precoding computation scheme is determined based on at least one of: a number of negative acknowledgements (NACKs) received from the plurality of UEs, channel state information indicating ill-conditioned channels between the base station and the plurality of UEs, or proximity of a number of the plurality of UEs. The distributed precoding computation parameters may be transmitted in one of: a radio resource control (RRC) message for configuration of a physical downlink shared channel (PDSCH), or a downlink control information (DCI) message on a physical downlink control channel (PDCCH). The distributed precoding computation parameters include at least one of: a parameter enabling/disabling distributed precoding computation; a parameter identifying a distributed precoding computation algorithm to be used for the precoding computation scheme; a number of iterations for the distributed precoding computation; or a maximum iteration time for the distributed precoding computation. The precoding computation scheme may also be determined based on at least one of: channel state information feedback from the plurality of UEs, or uplink reference signals transmitted by the plurality of UEs. The result of the local precoding computations may include an updated result after a specific iteration of a distributed precoding computation algorithm used for the precoding computation scheme. Precoders for the plurality of UEs may be determined by selecting a transformer-based precoding computation algorithm. The distributed precoding computation parameters that are transmitted may indicate trained neural network parameters for the transformer-based precoding computation algorithm. The result of the local precoding computations comprises: an output of a neural network encoder at each of the one or more of the plurality of UEs.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network within which distributed computation for precoding may be implemented according to embodiments of the present disclosure;

FIG. 2 illustrates an example gNB within which distributed computation for precoding may be implemented according to embodiments of the present disclosure;

FIG. 3 illustrates an example UE within which distributed computation for precoding may be implemented according to embodiments of the present disclosure;

FIG. 4A and FIG. 4B illustrate an example of wireless transmit and receive paths, respectively, within the gNB of FIG. 2 and/or the UE of FIG. 3;

FIG. 5 illustrates a flowchart of an example procedure for distributed precoding computation according to embodiments of the present disclosure;

FIG. 6 illustrates a diagram for an example of deep unfolding algorithms according to embodiments of the present disclosure;

FIG. 7 illustrates a diagram for an example architecture of distributed precoding computation in a downlink system according to embodiments of the present disclosure;

FIG. 8 illustrates a flowchart of an example of base station operation to support sum rate maximizing precoding during distributed computation for precoding according to embodiments of the present disclosure;

FIG. 9 illustrates a flowchart of an example of UE operation to support sum rate maximizing precoding during distributed computation for precoding according to embodiments of the present disclosure;

FIGS. 10 and 10A illustrate a transformer-based precoding architecture suitable for adaptation for use in distributed computation for precoding according to embodiments of the present disclosure;

FIG. 11 illustrates an alternative transformer-based precoding architecture suitable for adaptation for use in distributed computation for precoding according to embodiments of the present disclosure;

FIG. 12 illustrates another transformer-based precoding architecture suitable for adaptation for use in distributed computation for precoding according to embodiments of the present disclosure; and

FIG. 13 illustrates a MU-MIMO system.

### DETAILED DESCRIPTION

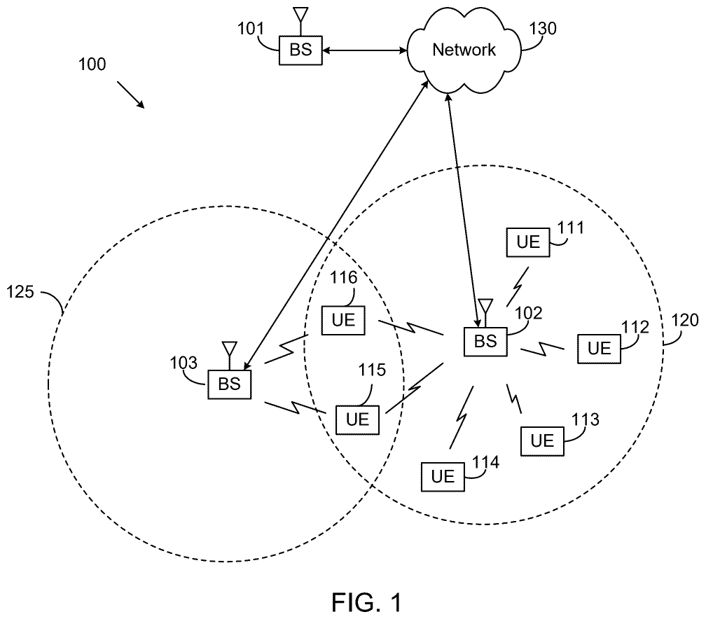

FIGS. 1-12, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

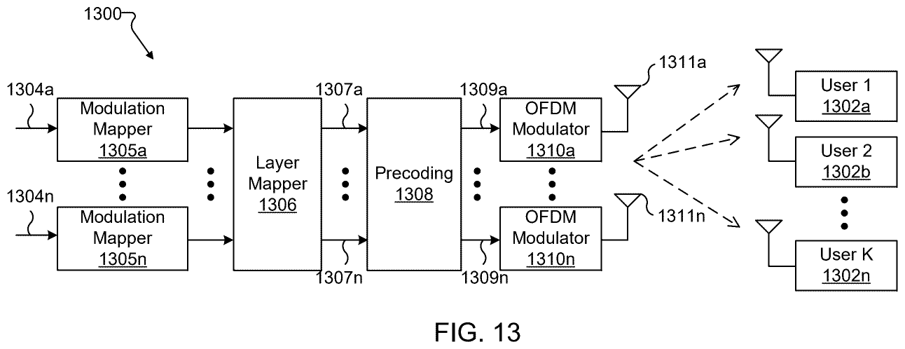

MIMO systems are known to significantly increase spectral efficiency by exploiting the spatial degrees of freedom. To fully realize the potential, especially in downlink broadcasting scenarios, design of transmit precoders is important. Multiple data streams to be sent to the users are weighted appropriately such that the link throughput is maximized at the receiver. As illustrated in the MIMO system 1300 of FIG. 13, after multiple data streams 1304a through 1304n to be sent to UEs 1302a, 1302b, . . . , 1302n are mapped by stream-specific modulation 1305a, 1305n and concurrent layer mapping 1306, the data streams 1307a through 1307n are sent through a precoding block 1308. The precoded data streams 1309a through 1309n are then mapped by OFDM modulators 1310a through 1310n to specific resource elements, which are mapped to the antenna ports 1311a through 131 In for transmission. The goal of precoding is to exploit the transmit diversity by weighting the information stream.

Dirty Paper Coding (DPC), a non-linear precoding method, has been shown to be capacity-achieving, but remains a theoretical benchmark due to the high computational burden. This makes linear downlink transmission techniques (also called beamforming) an attractive alternative because of their simplicity.

All inter-user interference is eliminated by zero-forcing (ZF) precoding, which is simple to implement but has poor performance in low signal-to-noise (SNR) regions. To address this drawback, regularized ZF precoding has been proposed, but finding optimal regularization terms is challenging. Block diagonalization (BD), an extension of the zero-forcing precoding technique for downlink multiuser MIMO systems, has been studied as a low-complexity (but suboptimal) strategy, where each UE's precoding matrix lies in the null space of all other UEs' channels.

Another approach for design of downlink (DL) transmit beamformers in MU-MIMO is to maximize weighted sum-rate (WSR) subject to a transmit power constraint, which is a non-convex and generally nondeterministic polynomial (NP)-hard problem.

Many approaches can be taken to solve the above problem(s). An iterative algorithm has been proposed, where the WSR problem is first equivalently transformed into a Weighted Sum-Minimum Mean Square Error (WMMSE) problem and then a block coordinate descent (BCD) method is employed to solve the resultant MMSE problem. The Iterative-WMMSE (IWMMSE) algorithm is widely regarded as a benchmark for WSR maximization since updates have a simple, well-known closed form expression while achieving a high WSR.

With advancement of machine learning (ML), many ML models can also be applied to solve this problem. One such approach could be to use deep unfolding to implement the above-described iterative methods, or to directly solve the optimization problem using the power of deep neural networks.

The following disclosure outlines methods to implement a distributed computation methodology for determining optimal linear precoders that is computationally light while maximizing the total sum rate.

### Abbreviations

ML Machine Learning
AI Artificial Intelligence
BS Base Station
UE User Equipment
WSR Weighted Sum Rate
WMMSE Weighted minimization of mean square error
ZF Zero forcing
RZF Regularized Zero forcing
BD Block Diagonalization
BCD Block coordinate descent
FDD Frequency Division Duplex
TDD Time Division Duplex
CSI Channel State Information
3GPP 3rd Generation Partnership Project
RRC Radio Resource Control
DCI Downlink Control Information
UCI Uplink Control Information
PDCCH Physical Downlink Control Channel
PDSCH Physical Downlink Shared Channel
PUCCH Physical Uplink Control Channel
PUSCH Physical Uplink Shared Channel
MAC CE Medium Access Control Control Element
DL Downlink
UL Uplink
LTE Long-Term Evolution

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to how different embodiments may be implemented. Different embodiments of the present disclosure may be implemented in any suitably arranged communications system.

FIG. 1 illustrates an example wireless network 100 within which distributed computation for precoding may be implemented according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for decoding of low-density parity check codes. In certain embodiments, one or more of the BSs 101-103 include circuitry, programing, or a combination thereof to support distributed computation for precoding.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

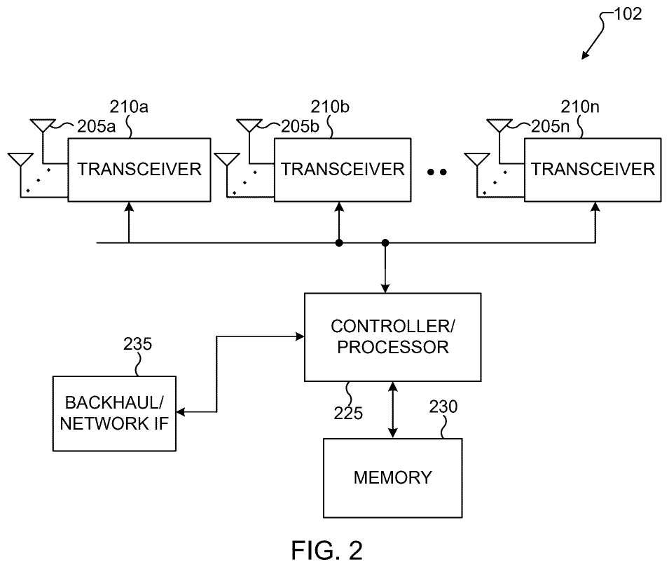

FIG. 2 illustrates an example gNB 102 within which distributed computation for precoding may be implemented according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for beam management in JPTA system with multiple component carriers. Any of a wide variety of other functions could be supported in the gNB 102 by the controller/processor 225.

The controller/processor 225 is also capable of executing programs and other processes resident in the memory 230, such as processes to trigger beam management in JPTA system with multiple component carriers. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

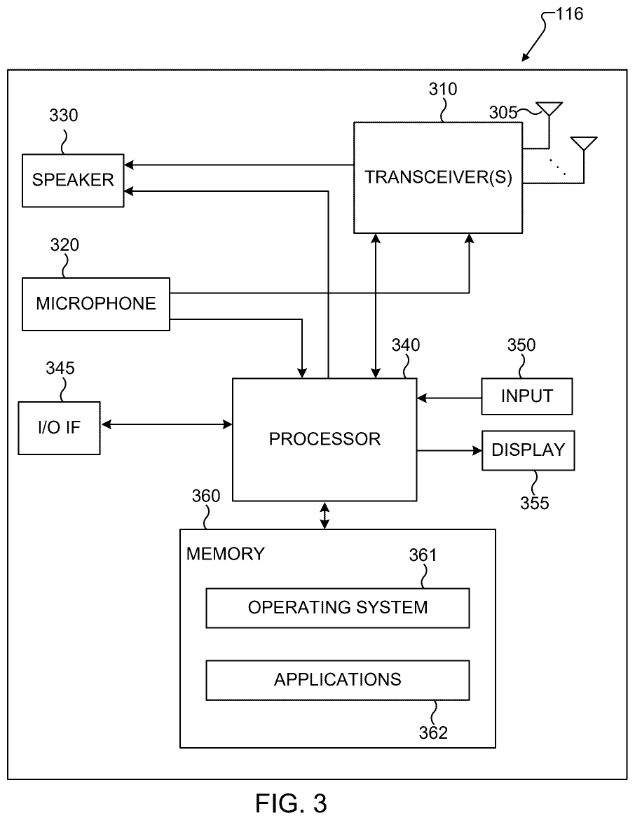

FIG. 3 illustrates an example UE 116 within which distributed computation for precoding may be implemented according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for beam management in JPTA system with multiple component carriers as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

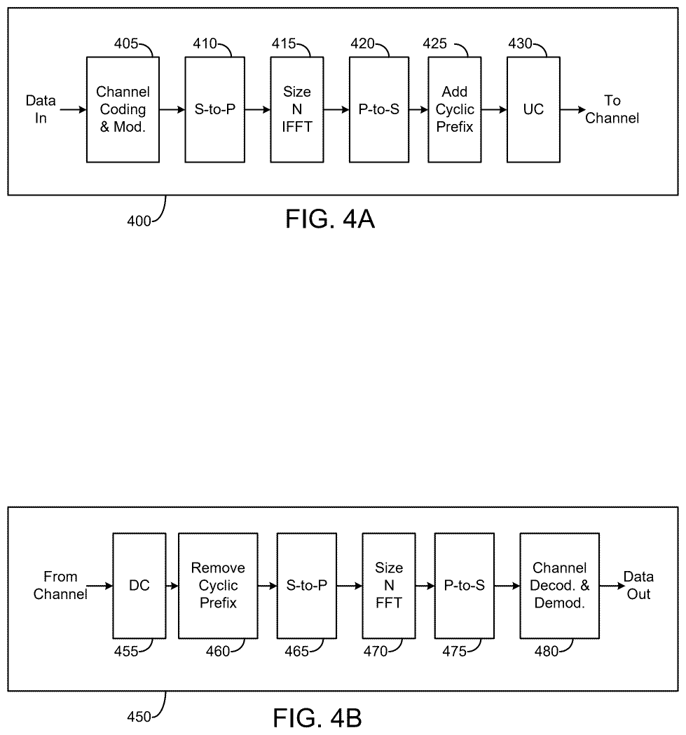

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured for decoding of low-density parity check codes as described in embodiments of the present disclosure. For example, embodiments of decoding of low-density parity check codes as described herein may be implemented in connection with channel decoding and demodulation 480 depicted in FIG. 4B.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Distributed implementation of various precoding approaches may require additional signaling between base station and users (UEs) along with a clear system design. Various iterative methods and/or machine learning methods can be implemented in a distributed fashion to offload computation and reduce complexity.

In a total sum rate maximization formulation, a downlink MU-MIMO system includes a base station equipped with Nₜ transmit antennas serving K UEs within the cell served by the base station, each UE equipped with Nᵣ transmit antennas. In one example, the number of data streams for all users can be equal, i.e., d≤Nᵣ data streams

Let Hₖ∈ [symbol] ^{N}^{ᵣ}^{×N}^{ₜ} be the MIMO channel matrix from the BS to UE k, and Vₖ∈ [symbol] ^{N}^{ₜ}^{×d} be the corresponding precoder matrix. The precoded transmit data vector is

$$x = {\sum }_{k} {V}_{k} {s}_{k}$$

where sₖ∈ [symbol] ^{d×1} is the data vector with zero mean and

$$E [ {s}_{k} {s}_{k}^{H} ] = I .$$

Thus, the received data vector at UE k, yₖ∈ [symbol] ^{d×1} is given by

$${y}_{k} = {H}_{k} {V}_{k} {s}_{k} + {\sum }_{i = 1 , i \neq k}^{K} {H}_{k} {V}_{i} {s}_{i} + {n}_{k} ∀ k ∈ [ 1 , 2 , … K ]$$

where nₖ∈ [symbol] _{d×1} represents the additive noise, which is modeled as a circularly symmetric complex Gaussian random vector with zero-mean and correlation matrix

$$CN ( 0 , {σ}_{k}^{2} ) ,$$

with

$${σ}_{k}^{2}$$

the average noise power at UE k.

The instantaneous signal-to-interference-ratio (SINR) at the k^{th} user is given by

$$SIN {R}_{k} = \frac{{H}_{k} {V}_{k} {V}_{k}^{H} {H}_{k}^{H}}{( {\sum }_{i \neq k} {H}_{k} {V}_{i} {V}_{i}^{H} {H}_{K}^{H} + {σ}_{k}^{2} I )} ,$$

and the rate is given by log det (I+SINRₖ).

As can be seen, the SINR seen by each UE is a function of precoders to all UEs, as interference plays a significant role and thus one cannot simply maximize individual UE SINR to optimize the total sum rate.

In one example of a WSR problem under equal power constraint, the equal power constraint and the problem of maximizing the sum rate is given as

$${max}_{\{ {V}_{k} \}} {\sum }_{k = 1}^{K} log det ( I + {H}_{k} {V}_{k} {V}_{k}^{H} {H}_{k}^{H} {( {\sum }_{i \neq k} {H}_{k} {V}_{i} {V}_{i}^{H} {H}_{K}^{H} + {σ}_{k}^{2} I )}^{- 1} ) , \qquad ( 1 )$$

$$s . t {\sum }_{i = 1}^{K} Tr ( {V}_{k} {V}_{k}^{H} ) = 1 , Tr ( {V}_{k} {V}_{k}^{H} ) = \frac{1}{K} ∀ k .$$

In another example, the total power constraint can be considered with

$${\sum }_{i = 1}^{K} Tr ( {V}_{k} {V}_{k}^{H} ) < P$$

with no constraint on any individual precoder power. This enables power allocation among precoders.

One of the many approaches to solve the non-convex optimization problem in equation (1) is by considering an equivalent minimization of mean square error (WMMSE) problem. In another example, this problem can be formulated as an unsupervised learning with a machine learning model trained to maximizing the total sum rate.

This disclosure presents a system model for the distributed implementation of various algorithms that aim to maximize the sum rate some of which are presented here.

In an equivalent WMMSE problem employing iterative methods, let Uₖ, Wₖ be the auxiliary variables indicating receiver matrix and weight matrix for the mean square error (MSE) matrix Eₖ of UE k.

In one implementation, the problem of weighted minimization of mean square error (WMMSE) may be solved:

$${min}_{\{ {U}_{k} , {W}_{k} , {V}_{k} \}} {\sum }_{k = 1}^{K} Tr ( {W}_{k} {E}_{k} ) - log det ( {W}_{k} ) \qquad ( 2 )$$

$$s . t {\sum }_{i = 1}^{K} Tr ( {V}_{k} {V}_{k}^{H} ) = 1 , Tr ( {V}_{k} {V}_{k}^{H} ) = \frac{1}{A} ∀ k$$

which is equivalent to solving the WSR problem in equation (1), in the sense that the optimal solution {Vₖ} is identical in both cases. The above problem in non-convex, but is convex in individual variables and in one embodiment by employing BCD the problem converges to a local optimum.

One algorithm implementing iterative WMMSE proceeds as follows:
Initialize {Vₖ} to satisfy the equal power constraint, with either a random initialization or a zero forcing (ZF) solution. Set tolerance ∈, maximum iterations Iₘₐₓ, and current iteration index t=0.
repeat

$$( U - Block : {F}_{U} ) ∀ k {U}_{k} = {A}_{k}^{- 1} {H}_{k} {V}_{k} , where \qquad ( 3 a )$$

$${A}_{k} = {σ}_{k}^{2} I + {\sum }_{i = 1}^{K} {H}_{k} {V}_{i} {V}_{i}^{H} {H}_{k}^{H} ,$$

$$( W - Block : {F}_{W} ) ∀ k {U}_{k} = {E}_{k}^{- 1} , {E}_{k} = I - {U}_{k}^{H} {H}_{k} {V}_{k} , \qquad ( 3 b )$$

$$( V - Block : {F}_{V} ) ∀ k : {V}_{k} = ∀ {B}^{- 1} {H}_{k}^{H} {U}_{k} {W}_{k} , where \qquad ( 3 c )$$

$$B = {\sum }_{k = 1}^{K} {σ}_{k}^{2} Tr ( {U}_{k} {W}_{k} {U}_{k}^{H} ) I + {\sum }_{i = 1}^{K} {H}_{i}^{H} {U}_{i} {W}_{i} {U}_{i}^{H} {H}_{i} ,$$

until the objective function converges based on the tolerance ε, and/or the number of iterations reaches Iₘₐₓ.

This disclosure refers to the number of BS transmit antennas Nₜ, the number of UE receive antennas Nᵣ, the number of streams per UE {d₁.,, d_{K}}, the total number of UEs K, and the total number of iterations T as configuration parameters.

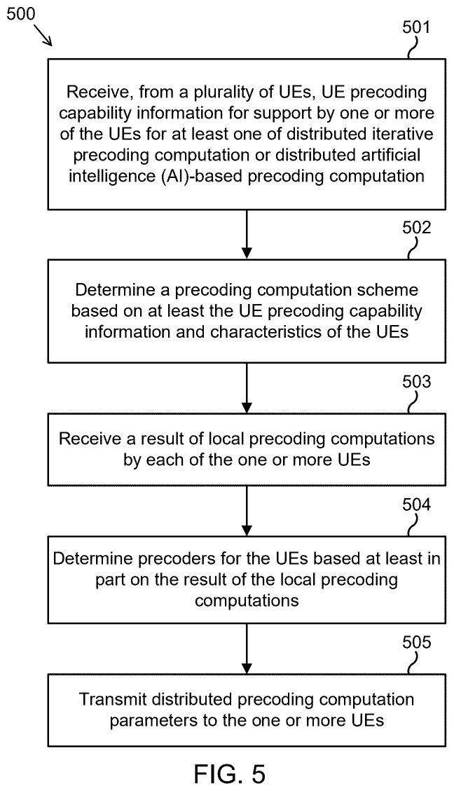

FIG. 5 illustrates a flowchart of an example process 500 for distributed precoding computation according to embodiments of the present disclosure. For example, procedure 500 for decoding of low-density parity check codes can be performed by the gNB 102, operating in conjunction with the UES 111-116 and/or network 130 in the wireless network 100 of FIG. 1. This example is for illustration only and other embodiments can be used without departing from the scope of the present disclosure.

The process 500 begins with receiving, from a plurality of UEs served by a base station, UE precoding capability information for support by one or more of the UEs for at least one of distributed iterative precoding computation or distributed artificial intelligence (AI)-based precoding computation (operation 501). The UE precoding capability information may be received by a UCI in a PUCCH or a MAC CE identified by a MAC PDU in a PDSCH. A precoding computation scheme is determined based on at least the UE precoding capability information and characteristics of the plurality of UEs (operation 502). The precoding computation scheme may be determined based on a number of NACKs, CSI indicating ill-conditioned channels, and/or proximity of some of the UEs. The precoding computation scheme may also be determined based CSI feedback from the UEs, or uplink reference signals transmitted by the UEs. Results of local precoding computations by the one or more UEs are received (operation 503). The results of the local precoding computations may include an updated result after a specific iteration of a distributed precoding computation algorithm. For transformer-based precoding computation, the results of the local precoding computations may include an output of a neural network encoder at each of the UEs. Precoders for the UEs are determined based on the results of the local precoding computations (operation 504). The precoders may be determined using a transformer-based precoding computation algorithm. Distributed precoding computation parameters are transmitted to the UEs (operation 505). The distributed precoding computation parameters may include any one or more one of: a parameter enabling/disabling distributed precoding computation; a parameter identifying a distributed precoding computation algorithm to be used for the precoding computation scheme; a number of iterations for the distributed precoding computation; or a maximum iteration time for the distributed precoding computation. For transformer-based precoding computation, the distributed precoding computation parameters may indicate trained neural network parameters.

Although FIG. 5 illustrates one example of a process 500 for distributed precoding computation, various changes may be made to FIG. 5. For example, while shown as a series of steps, various steps in FIG. 5 could overlap, occur in parallel, occur in a different order, or occur any number of times (including zero times).

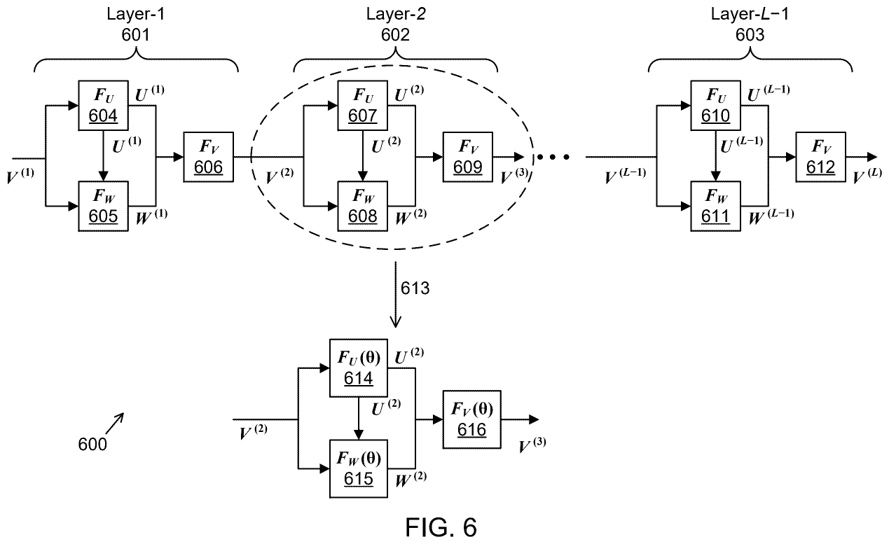

FIG. 6 illustrates a diagram for an example 600 of deep unfolding algorithms according to embodiments of the present disclosure. For instance, the example 600 can be implemented in a distributed fashion by any combination of the gNB 102 and/or the UEs 111-116 of FIG. 1. This example is for illustration only and other embodiments can be used without departing from the scope of the present disclosure.

In one example of a machine-learning approach, model-based neural networks such as a deep unfolding network may be implemented. For equations (3a), (3b), and (3c) above, L layers comprising layer-1 601, layer-2 602, through layer-L−1 603 may be implemented. Each layer includes computation of F_{U} as set forth in equation (3a) by respective blocks 604, 607, and 610; computation of F_{W} as set forth in equation (3b) by respective blocks 605, 608, 611; and computation of F_{V} as set forth in equation (3c) by respective blocks 606, 609, 611. The update blocks in each iteration (layer) may be replaced 613 by a function of trainable parameters θ in blocks 614, 615, and 616.

In some embodiments, the per-iteration complexity may be directly reduced, thus aiding in reduction of overall complexity by replacing the highly complex matrix inversion operations with trainable low complexity operations. In other embodiments, parametrization may be employed in order to aid with convergence, such that the algorithm converges to global optimum with less iterations.

Although FIG. 6 illustrates an example of deep unfolding algorithms, various changes to the algorithm depicted may be made. For instance, the number of layers 601 through 603 may vary, or the trainable parameters in blocks 614, 615, and 616 for each layer may be implemented for serial, parallel, or overlapping determination.

The concept of unfolding entails adopting the architecture of a neural network from a hand-crafted iterative algorithm, then modifying and parameterizing the architecture as illustrated in FIG. 6, where each iteration of the deep unfolding algorithms is unfolded into a neural network layer. By learning the optimal value of the network parameters from data, a network that is at least as performant as the original method while being computationally more efficient can be obtained. There are options of how to parameterize the iterative algorithm.

One of the main advantages of a deep unfolding approach is the use of less training data. To re-tune the trained model for a different scenario, just a few hundreds of samples of training data can be sufficient.

In one example, a single trained model can be sufficient for various configuration parameters, i.e., increasing the number of streams per user or increasing a number of users scheduled does not require model re-training. In another example, different models can be trained for each set of configuration parameters, i.e., a model trained for users with four antennas would not be used for inference for users with eight receive antennas.

In employing distributed implementation of various approaches, the iterative WMMSE algorithm and/or model-based deep unfolding algorithms can be implemented in distributed fashion, where the U-Block and W-Block in equations (3a) and (3b) can be implemented at the UE. The UE may need to know the channel towards the BS, and information about the precoder assigned to the UE. The UE may also need to estimate received data covariance matrix, Aₖ. The BS can update the precoders for all UEs and may require only the matrices UₖWₖUₖ^{H}, UₖWₖ from all UEs.

Depending on the network type, the term “base station” or “BS” can refer to any component (or collection of components) configured to provide wireless access to a network, such as transmit point (TP), transmit-receive point (TRP), an enhanced base station (eNodeB or gNodeB), a macrocell, a femtocell, a WiFi access point (AP), a distributed unit (DU), a radio unit (RU) or other wirelessly enabled devices. Base stations may provide wireless access in accordance with one or more wireless communication protocols, e.g., 5G 3GPP New Radio (NR) Interface/Access, LTE, LTE advanced (LTE-A), High Speed Packet Access (HSPA), Wi-Fi 802.11a/b/g/n/ac, etc. For the sake of convenience, the terms “BS” and “TRP” are used interchangeably in this document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

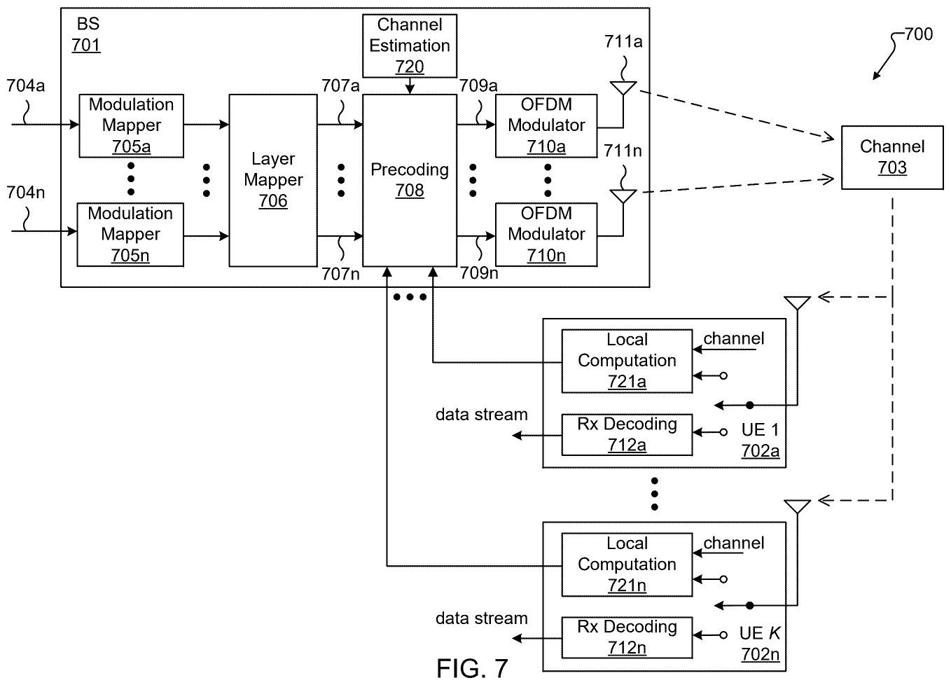

FIG. 7 illustrates a diagram for an example system 700 of distributed precoding computation in a downlink system according to embodiments of the present disclosure. For instance, the example system 700 can be implemented in a distributed fashion by any combination of the gNB 102 and/or the UEs 111-116 of FIG. 1. This example is for illustration only and other embodiments can be used without departing from the scope of the present disclosure.

The system 700 in the example of FIG. 7 includes a base station 701, UEs 702a through 702n, and the channel 703 between the base station 701 and each of the UEs 702a through 702n. The base station 701 may be, for instance, gNB 102 in FIG. 1, and the UEs 702a through 702n may be UEs 111-116 in FIG. 1.

In deploying distributed computation for precoding in multi-user MIMO downlink scenarios, the base station 701 receives multiple data streams 704a through 704n to be sent to UEs 702a through 702n. The data streams 704a through 704n are grouped and mapped by one of stream-specific modulation mappers 705a through 705n to modulation symbols. Layer mapping 706 distributes the modulated symbols across one or multiple layers for transmission using multiple antennas, producing data streams 707a through 707n based on the outputs of modulation mappers 705a through 705n. Data streams 707a through 707n are sent to a precoding block 708 for precoding. The precoded data streams 709a through 709n are then mapped by OFDM modulators 710a through 710n to specific resource elements, which are then mapped to the antenna ports 711a through 71 In for transmission via the channel 703. All UEs 702a through 702n implement respective receiver decoding pipeline 712a through 712n to get receive intended data.

In the system 700, the channel 703 to all UEs 702a through 702n is estimated at the base station 701 by channel estimation 720. In one example, the channel 703 can be estimated using SRS sent by the respective UE 702a through 702n, in configurations such as TDD systems. In another example, as with FDD systems, the channel is estimated at each UE using CSI-RS, then is sent back to base station 701 using Type-1/Type-2 CSI feedback. Precoder computation is performed by precoding block 708 based either using the estimated channel to all the users determined by channel estimation 720, or employing the outputs of a distributed implementation where certain local computations 721a through 721n implemented at individual UEs is also used for computing precoders.

In some embodiments, iterative methods are used for precoding computation, in which certain computations may need to be at each UE for every iteration for a certain number of iterations based on local channel and the feedback sent from the base station 701 after each iteration. Local computations 721a through 721n at each UE 702a through 702n can implement either certain blocks from the iterative methods or certain machine learning models, taking as input either the channel or both channel and feedback received from the base station 701. In some embodiments, the local c computations 721a through 721n can include mapping CSI to latent space or to a specific codebook predefined in the 3GPP standards.

Although FIG. 7 illustrates an example system for distributed precoding computation, various changes to the system depicted may be made. For instance, the number of base stations or UEs may vary, the network 130 in FIG. 1 may perform some functions relevant to distributed precoding computation, or portions of the precoders employed, and computed as described below, may be accessed via lookup tables.

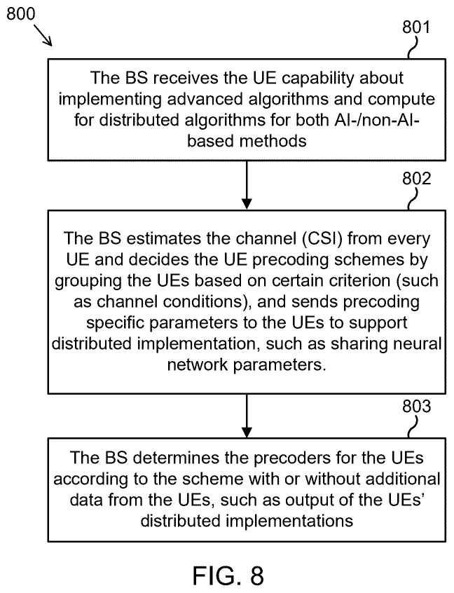

FIG. 8 illustrates a flowchart of an example of base station operation 800 to support sum rate maximizing precoding during distributed computation for precoding according to embodiments of the present disclosure. For example, base station operation 800 can be performed by the gNB 102 in connection with the UE 116 in the wireless network 100 of FIG. 1. This example is for illustration only and other embodiments can be used without departing from the scope of the present disclosure.

The example base station operation 800 begins with the base station receiving UE capability to support neural network computation or iterative methods for distributed implementation (operation 801). The UE capability information can include one or multiple items of capability information, such as the capability to implement neural network modules and/or the capability to support distributed implementation of iterative methods that involve sharing and/or receiving data with base station after every iteration.

The report of the capability information can be received via PUCCH as UCI. In another embodiment, a MAC CE identified by a MAC packet data unit (PDU) subheader may be carried in a PUSCH, used to indicate UE precoding capability.

The base station estimates the channel to every UE within the respective cell (operation 802). The existing formulation in 3GPP standards, such as CSI feedback in case of FDD and with help of SRS in case of TDD systems, may be utilized. The base station can employ various trained models deployed to implement one or many sum rate maximizing precoding schemes. These trained models can be fine-tuned with channel data specific to the site, and accordingly data collection for such fine-tuning can be triggered. In one embodiment, the trigger can be a result of increase in the number of transmission failures, such as number of negative acknowledgements (NACKs) when these models were used for precoding. When triggered, in one embodiment, the base station can offload the estimated channel data to a data center for fine-tuning. In another embodiment, the base station can perform fine-tuning at the base station's own location, especially with deep unfolding techniques that do not require more data. The base station can receive updated model parameters as a result of fine-tuning.

The base station then decides the precoding schemes for the scheduled UEs and deploys the respective models (also operation 802). In one embodiment, the base station can group the users to have one group of users with baseline precoding such as zero-forcing (ZF), regularized ZF (RZF), block diagonalization (BD), or other approaches that may require a distributed computation. In one example, the base station can schedule users with highly correlated/ill-conditioned channels or clustered users with distributed computation aided precoding.

When distributed implementation for iterative algorithms is enabled, the base station may send the related configuration information to the UE, which can include the specific scheme used such as IWMMSE, one of the deep unfolding algorithms, a number of iterations, and deep unfolding related trained parameters. A part or all of the configuration information can be sent via UE-specific signaling, or via group-specific signaling.

In one embodiment, the base station can use higher layer signaling such as a single-bit DistributedPrecoding field in the PDSCH-config RRC message to enable/disable distributed computation for precoding and DistPrecodingAlg field to communicate the specific precoding algorithm for the RRC connection. In another embodiment a single field DistPrecodingAlg can be used to both enable and communicate specific algorithm. The pseudo-code below illustrates a field in RRC message PDSCH-config for an embodiment with distributed computation:

| | |
|---|---|
| PDSCH-Config : : = | SEQUENCE { OPTIONAL, -- Need S |

```
  dataScramblingIdentityPDSCH INTEGER (0 . . 1023)
              OPTIONAL -- Need M
  dmrs-DownlinkForPDSCH-MappingTypeA SetupRelease { DMRS-
            DownlinkConfig } OPTIONAL -- Need M
  dmrs-DownlinkForPDSCH-MappingTypeB SetupRelease { DMRS-
            DownlinkConfig } OPTIONAL -- Need M
```

| | |
|---|---|
| tci-StatesToAddModList | SEQUENCE (SIZE (1 . . |

```
            maxNrofTCI-States )) OF TCI-State
              OPTIONAL -- Need N
```

| | |
|---|---|
| tci-StatesToReleaseList | SEQUENCE (SIZE (1 . . |

```
            maxNrofTCI-States )) OF TCI-StateId
              OPTIONAL -- Need N
```

| | |
|---|---|
| vrb-ToPRB-Interleaver | ENUMERATED { n2, n4} |

OPTIONAL -- Need S

| | |
|---|---|
| resourceAllo cation | ENUMERATED { |
| | resourceAllocationTypeO, |

```
            resourceAllocationType1, dynamicSwitch },
  pdsch-TimeDomainAllocationList SetupRelease { PDSCH-
            TimeDomainResourceAllocationList I OPTIONAL, -
            - Need M
```

| | |
|---|---|
| pdsch-AggregationFactor | ENUMERATED { n2, n 4 , n8 } |
| | OPTIONAL, -- Need S |

```
  rateMatchPatternToAddModList SEQUENCE (SIZE (1 . .
            maxNrofRateMatchPatterns)) OF RateMatchPattern
            OPTIONAL, -- Need N
  rateMatchPatternToReleaseList SEQUENCE (SIZE (1 . .
            maxNrofRateMatchPatterns)) OF
            RateMatchPatternId OPTIONAL, -- Need N
```

| | |
|---|---|
| rateMatchPatternGroup1 | RateMatchPatternGroup OPTIONAL, |

-- Need R

| | |
|---|---|
| rateMatchPatternGroup2 | RateMatchPatternGroup OPTIONAL, |

-- Need R

| | |
|---|---|
| distributePrecoding | BOOLEAN |
| distPrecodingAlg | INTEGER (0 . . 3) |
| NumIter | INTEGER (0 . . 7) |
| MaxIterTime | INTEGER (0 . . 7) |

The base station has to communicate the maximum number of iterations for any iterative algorithm and in one embodiment, such communication can be performed using higher layer signaling such as NumIter field in the PDSCH-config RRC message as in the above pseudo-code, or by using a field NumIter in DCI message in PDCCH.

In one embodiment, the base station can set the maximum time for the UE to complete the UE's computation for each iteration and send the feedback, so that the base station can wait for that time to gather all the updates from UEs before computing the precoder. This can be communicated to user by using a field MaxIterTime in a PDSCH-config RRC message (see above pseudo code), or in DCI message in PDCCH.

In one embodiment, the beginning of the iterations can be triggered when the UE receives the information from the base station, such as the UE's specific precoder or deep unfolding related parameters. In one embodiment, the data transmission between the base station and the UE, such as the specific precoder or the updated matrices computed at UE, can be communicated using data respective DL/UL data transmission schemes.

The base station determines the precoder (operation 803). In one example, the base station can implement any of the algorithms based on the scheduled UEs' channel and determine precoders. In one example, based on the configuration parameters, such as number of users and corresponding rank, the specific trained neural network model can be deployed for inference. In another example, the same model can be used.

Although FIG. 8 illustrates one example of base station operation 800 to support sum rate maximizing precoding during distributed computation for precoding, various changes may be made to FIG. 8. For example, while shown as a series of steps, various steps in FIG. 8 could overlap, occur in parallel, occur in a different order, or occur any number of times (including zero times).

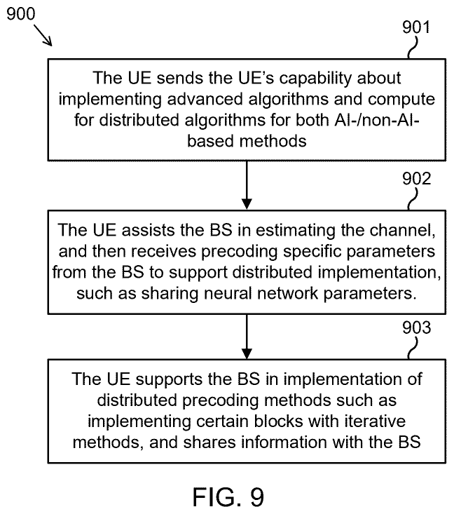

FIG. 9 illustrates a flowchart of an example of UE operation 900 to support sum rate maximizing precoding during distributed computation for precoding according to embodiments of the present disclosure. For example, UE operation 900 can be performed by the UE 116 in connection with the gNB 102 in the wireless network 100 of FIG. 1. This example is for illustration only and other embodiments can be used without departing from the scope of the present disclosure.

The UE operation 900 begins with the UE sending, to a serving base station, the UE capability to support neural network computation or iterative methods for distributed implementation (operation 901). The UE capability information can include one or multiple information such as the capability to implement neural network modules and/or capability to support distributed implementation of iterative methods that involve sharing/receiving data with the base station after every iteration.

The report of the capability information can be sent via Physical uplink control channel (PUCCH) as an Uplink control information (UCI). In another embodiment, a MAC CE identified by a MAC PDU subheader to be carried in a Physical uplink shared channel (PUSCH) can be used to indicate UE precoding capability.

The UE aids the base station with acquiring channel state information (operation 902), by either estimating and communicating the channel to the base station in FDD systems or by sending an SRS as in TDD systems. The UE can receive additional configuration information as may be needed to help with distributed implementation, such as neural network parameters as described above.

The UE may need to communicate with the base station (operation 903) after completing local computation (e.g., local computations 721a in FIG. 7), to support implementing distributed algorithms. In one example, UE can use existing specification supported CSI-ReportConfig. In another example, the UE can send the results using the uplink data transmission such as PUSCH.

Although FIG. 9 illustrates one example of UE operation 900 to support sum rate maximizing precoding during distributed computation for precoding, various changes may be made to FIG. 9. For example, while shown as a series of steps, various steps in FIG. 9 could overlap, occur in parallel, occur in a different order, or occur any number of times (including zero times).

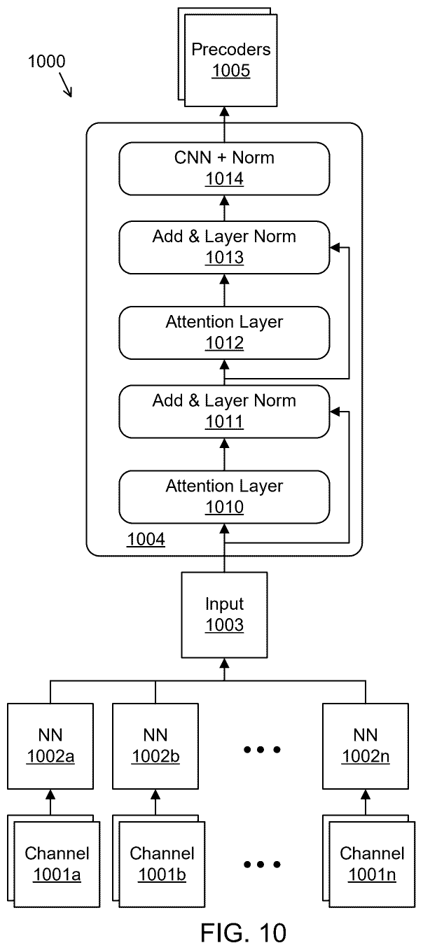

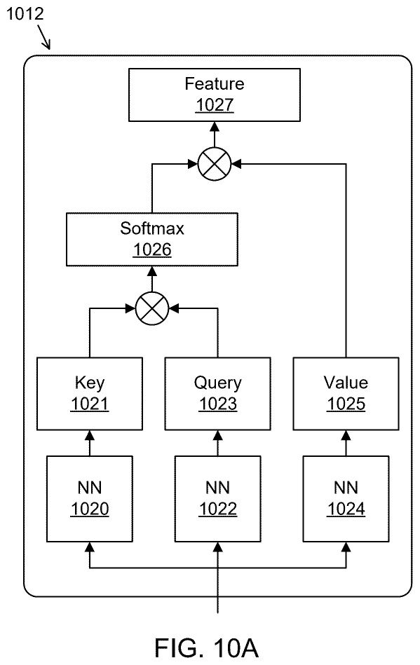

FIGS. 10 and 10A illustrate a transformer-based precoding architecture 1000 suitable for adaptation for use in distributed computation for precoding according to embodiments of the present disclosure. For example, the transformer-based precoding architecture 1000 can be implemented within the gNB 102 in the wireless network 100 of FIG. 1, and adapted as described herein for distributed performance with the UE 116. This example is for illustration only and other embodiments can be used without departing from the scope of the present disclosure.

The transformer-based precoding architecture 1000 of FIG. 10 considers the full rank channels Hᵢ from K UEs of dimension Nᵣ×Nₜ×2, where 2 refers to the real and imaginary values. Accordingly, information on K Nᵣ×Nₜ×2 channels 1001a, 1001b, . . . , 1001n is utilized. In one implementation, the transformer network 1004 within the transformer-based precoding architecture 1000 can be trained for a maximum of K UEs, and if less than K UEs are scheduled, the remaining (unused) inputs are masked. In another implementation, different models can be trained for different numbers of UEs.

The information the channels 1001a, 1001b, . . . , 1001n is processes in neural networks (NNs) 1002a, 1002b, . . . , 1002n. The purpose of NNs 1002a, 1002b, . . . , 1002n is to extract relevant features from UE's channels, which is referred to as the encoding process in this disclosure. In one implementation, a simple convolutional neural network (CNN) layer can be used to extract important features representing the correlation within the channels. In another implementation, a simple reshaping of the channel into a single column can be considered, where the channel can be sent through a fully connected layer. Encoding can also include various dimensionality reduction methods such as principal component analysis (PCA), singular value decomposition (SVD), an encoder with residual blocks, generative adversarial networks (GANs). Such dimensionality reduction methods can effectively map higher dimensional channel data to a well-represented low-dimensional latent space. The encoding process can include non-AI methods as well, such as considering the region of interest, representations of the channel(s) in different transformation domains such as delay/angle domains, truncation of the channel(s), and well-established CSI feedback methods such as Type-1/Type-2 CSI feedback in FDD systems.

The K×M input 1003 to the transformer network 1004 represents the concatenated K output features extracted by NNs 1002a, 1002b, . . . , 1002n, each of dimension M. The transformer network 1004 includes multiple attention layers 1010 and 1012 as illustrated FIG. 10. The purpose of using attention layers 1010, 1012 is to capture the inter-dependence of channels on each other—that is, obtain inter-UE interference features. In the exemplary transformer network 1004, the series of attention layers 1010, 1012 are each followed by a respective add and normalization layer 1011, 1013, and are followed by a CNN and normalization layer 1014, with final output being the K×Nᵣ×Nₜ×2 precoders 1005 of an appropriate dimension.

FIG. 10A illustrates the attention layers of FIG. 10 in greater detail, with attention layer 1012 used as also representative of attention layer 1010. In the exemplary attention layer, NN 1020 determines embeddings for determination of a key vector 1021; NN 1022 determines embeddings for determination of a query vector 1023; and NN 1024 determines embeddings for determination of a value vector 1025. A softmax function 1026 is applied to the combined outputs of the determination of the key vector 1021 and the determination of the query vector 1023, to compute attention scores. The output of the softmax function 1026 and the output of the determination of the value vector 1025 are combined in a weighted sum to derive feature output 1027.

In order to maximize the weighted sum rate, in one example, the transformer network 1004 can be trained in an unsupervised fashion, with negative total sum rate as the loss function. In another example, the transformer network 1004 can be trained in a two-step process, where training is first done in a supervised fashion with well-known baseline precoders (such as ZF precoders or BD precoders) as labels, and then further trained in an unsupervised fashion treating the total sum rate as loss function.

For distributed implementation of transformer-based precoding of the type illustrated by FIGS. 10 and 10A, in one embodiment the models can be deployed in distributed fashion, such as in transformer networks for individual UEs to encode the UE's specific channels and share just the encoded output to base station. In this example, the feedback overhead can be reduced, with UEs sharing the encoded feature instead of channel information, which can be very helpful in FDD systems where CSI feedback encounters a larger overhead.

In one embodiment, the base station can use higher layer signaling such as a single-bit DistributedPrecoding field in the PDSCH-config RRC message as shown above, to enable/disable distributed computation for precoding, and the DistPrecodingAlg field can be used to communicate the specific precoding algorithm for the RRC connection. In another embodiment a single field DistPrecodingAlg can be used to both enable and communicate specific algorithm.

In one embodiment, the base station can send the trained parameters to the UE using DL data transmission schemes. In one embodiment, specific tokenization methods can be predefined and the base station can send index information to select a specific tokenization method, using either DCI or RRC messages.

Although FIGS. 10 and 10A illustrate one example of a transformer-based precoding architecture 1000, various changes may be made to FIGS. 10 and 10A. For example, the number of layers in FIGS. 10 and 10A could be varied, and other neural network mechanisms may be included.

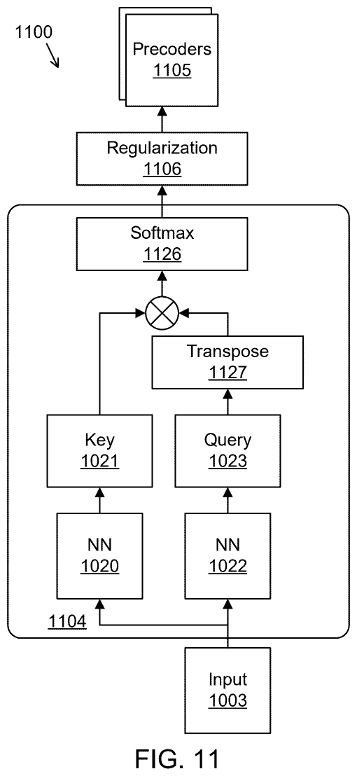

FIG. 11 illustrates an alternative transformer-based precoding architecture 1100 suitable for adaptation for use in distributed computation for precoding according to embodiments of the present disclosure. For example, the transformer-based precoding architecture 1100 can be implemented within the gNB 102 in the wireless network 100 of FIG. 1, and adapted as described herein for distributed performance with the UE 116. This example is for illustration only and other embodiments can be used without departing from the scope of the present disclosure.

The transformer-based precoding architecture 1100 of FIG. 11 implements an attention-based regularization precoding, using the attention scores as regularization parameters.

While ZF precoders attempt to nullify interference and match-filter precoders attempt to maximize the signal strength of each UE, there exists a range of linear precoders between these two extremes referred to as regularized ZF precoders. Regularized ZF precoders are r given by H^{H} (HH^{H}+αI)⁻¹, where H is the channel matrix, H^{H} is the Hermitian transpose of the channel matrix, I is the identify matrix, and α (of dimension K×K) is the regularization parameter matrix. Finding the optimal regularization parameter is complicated as the SINR at each UE depends not only on the precoder for that stream, but on every precoder for every UE.

Thus, in one embodiment, the transformer-based precoding architecture 1100 can be trained be to learn regularization parameters in RZF precoders. For example, a transformer network 1104 can output the attention map as illustrated in FIG. 11, and the attention map can be treated as the regularization parameter in regularization 1106 for RZF precoding. Similar to the attention layer 1012 in FIG. 10A, in the exemplary transformer network 1104, NN 1020 determines embeddings for determination of a key vector 1021, and NN 1022 determines embeddings for determination of a query vector 1023. A softmax function 1126 is applied to the combined outputs of the determination of the key vector 1021 and the transpose 1127 of the determination of the query vector 1023, to compute attention scores. Since attention scores attempt to capture the inter-dependencies of the input 1003 (i.e., channels), the attention map may can be seen as capturing the impact a particular user on other UE's, in terms interference caused. As illustrated, in regularization 1106, the RZF precoders 1105 can be computed using the attention map of dimension K×K as the regularization term a. This can also be implemented in distributed fashion as described above.

Although FIG. 11 illustrates one example of an alternative transformer-based precoding architecture 1100, various changes may be made to FIG. 11. For example, the number of layers in FIG. 11 could be varied, and other neural network mechanisms may be included.

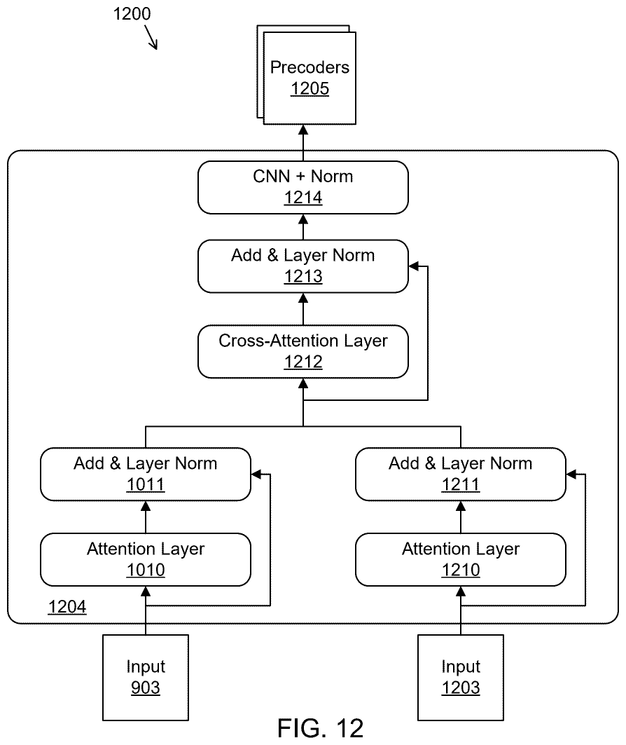

FIG. 12 illustrates another transformer-based precoding architecture 1200 suitable for adaptation for use in distributed computation for precoding according to embodiments of the present disclosure. For example, the transformer-based precoding architecture 1200 can be implemented within the gNB 102 in the wireless network 100 of FIG. 1, and adapted as described herein for distributed performance with the UE 116. This example is for illustration only and other embodiments can be used without departing from the scope of the present disclosure.

The transformer-based precoding architecture 1200 of FIG. 12 implements cross-attention based precoding, employing cross-attention layers between estimated channels and feedback from UEs.

The transformer network 1204 extends the transformer network 1004 of FIG. 10. The same K×M input 1003 is operated on by attention layer 1010 and add and normalization layer 1011. However, the input 1003 represents a first set of UEs: set-1. The same process shown in FIG. 10 to determine input 1003 is also employed to determine a K×M input 1203 for a second set of UEs, set-2. The input 1203 is operated on by attention layer 1210 and add and normalization layer 1211.

In one embodiment, a cross-attention layer 1212 can be deployed to exploit multiple different features extracted from different input data (input 1003 and input 1203) to help obtain a better inter-user interference feature.

In one example, the cross-attention layer 1212 can be applied to consider both inter-cell and intra-cell UE interference. One set of attention layer(s) 1010 can be applied to channel from UEs within the cell (e.g., input 1003), capturing the intra-cell user interference features, while the other set of attention layer(s) 1210 can be applied to small feedback from UEs at different cells (e.g., input 1203), capturing inter-cell user interference features. The cross-attention layer 1212 can be used to combine the two as in FIG. 12. The cross-attention layer 1212 may be followed by add and normalization layer 1213 and a CNN and normalization layer 1214, with final output being precoders 1205.

In another example, the base station can group UEs into two groups based on correlation, such as by grouping UEs co-located at same location (clustered UEs) in one group and the rest in another group. The encoding process (i.e., the local computations 721a through 721n at UEs 702a through 702n) for both sets of users can be different, using a complex model for clustered UEs as inter-user interference is high for such UEs. Combining inter-user interference features from both sets of UEs can be achieved from the cross-attention layer 1212.

In another example, both the estimated channels and the additional feedback received from the UEs can be used to compute the inter-user interference features, where additional feedback can help in designing precoders by helping determine the inter-user interference.

Although FIG. 12 illustrates one example of a transformer-based precoding architecture 1200, various changes may be made to FIG. 12. For example, the number of layers in FIG. 12 could be varied, and other neural network mechanisms may be included.

Precoding is one of the key enabling physical layer technologies in wireless communication systems. The disclosed technology's transformer-based and deep unfolding algorithms provide gains over traditional precoding schemes, with large gains in scenarios with clustered users with low SNR. Distributed implementation of such techniques can further reduce the complexity and communication overhead while maintaining performance close to the achievable rate.

The present disclosure provides a framework and signaling between a base station and UEs to implement at least one of iterative precoding or AI-based precoding that maximizes a total sum rate.

The present disclosure also provides transformer-based precoding that utilizes an attention mechanism to capture one or more inter-user interferences, and further provides a distributed implementation to reduce an overhead of data to be exchanged.

The present disclosure still further provides one or more attention mechanisms to capture one or more inter-user interferences based on at least one of: 1) utilizing a precoding approach or 2) capturing at least some intra-cell interference and at least some inter-cell interference with one or more cross-attention mechanisms.

The precoding solutions of the disclosed technology can be used to improving system throughput with reduced complexity due to the distributed implementation. The disclosed technology can also be extended to multi-cell scenarios in wireless communication systems.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method performed by a base station for distributed precoding computation, the method comprising:
receiving, from a plurality of user equipments (UEs) served by the base station, UE precoding capability information for support by one or more of the plurality of UEs for at least one of distributed iterative precoding computation or distributed artificial intelligence (AI)-based precoding computation;
determining a precoding computation scheme based on at least the UE precoding capability information and characteristics of the plurality of UEs served by the base station;
receiving a result of local precoding computations by each of the one or more of the plurality of UEs;
determining precoders for the plurality of UEs based at least in part on the result of the local precoding computations; and
transmitting distributed precoding computation parameters to the one or more of the plurality of UEs.

2. The method of claim 1, wherein the UE precoding capability information is received by one of:
an uplink control information (UCI) in a physical uplink control channel (PUCCH), or
a medium access control (MAC) control element (CE) identified by a MAC protocol data unit (PDU) in a physical uplink shared channel (PUSCH).

3. The method of claim 1, wherein the precoding computation scheme is determined based on at least one of:
a number of negative acknowledgements (NACKs) received from the plurality of UEs,
channel state information indicating ill-conditioned channels between the base station and the plurality of UEs, or
proximity of a number of the plurality of UEs.

4. The method of claim 1, wherein the distributed precoding computation parameters are transmitted in one of:
a radio resource control (RRC) message for configuration of a physical downlink shared channel (PDSCH), or
a downlink control information (DCI) message on a physical downlink control channel (PDCCH).

5. The method of claim 1, wherein the distributed precoding computation parameters comprise at least one of:
a parameter enabling/disabling distributed precoding computation,
a parameter identifying a distributed precoding computation algorithm to be used for the precoding computation scheme,
a number of iterations for the distributed precoding computation, or
a maximum iteration time for the distributed precoding computation.

6. The method of claim 1, wherein the precoding computation scheme is determined based also on at least one of:
channel state information feedback from the plurality of UEs, or
uplink reference signals transmitted by the plurality of UEs.

7. The method of claim 1, wherein the result of the local precoding computations comprises:
an updated result after a specific iteration of a distributed precoding computation algorithm used for the precoding computation scheme.

8. The method of claim 1, wherein determining precoders for the plurality of UEs further comprises:
selecting a transformer-based precoding computation algorithm.

9. The method of claim 8, wherein transmitting distributed precoding computation parameters further comprises:
indicating trained neural network parameters for the transformer-based precoding computation algorithm.

10. The method of claim 8, wherein the result of the local precoding computations comprises:
an output of a neural network encoder at each of the one or more of the plurality of UEs.

11. A base station for distributed precoding computation, the base station comprising:
a transceiver configured to receive, from a plurality of user equipments (UEs) served by the base station, UE precoding capability information for support by one or more of the plurality of UEs for at least one of distributed iterative precoding computation or distributed artificial intelligence (AI)-based precoding computation; and
at least one processing device coupled to the transceiver and configured to:
determine a precoding computation scheme based on at least the UE precoding capability information and characteristics of the plurality of UEs served by the base station,
receive a result of local precoding computations by each of the one or more of the plurality of UEs,
determine precoders for the plurality of UEs based at least in part on the result of the local precoding computations, and
transmit distributed precoding computation parameters to the one or more of the plurality of UEs.

12. The base station of claim 11, wherein the UE precoding capability information is received by one of:
an uplink control information (UCI) in a physical uplink control channel (PUCCH), or
a medium access control (MAC) control element (CE) identified by a MAC protocol data unit (PDU) in a physical uplink shared channel (PUSCH).

13. The base station of claim 11, wherein the precoding computation scheme is determined based on at least one of:
a number of negative acknowledgements (NACKs) received from the plurality of UEs,
channel state information indicating ill-conditioned channels between the base station and the plurality of UEs, or
proximity of a number of the plurality of UEs.

14. The base station of claim 11, wherein the distributed precoding computation parameters are transmitted in one of:
a radio resource control (RRC) message for configuration of a physical downlink shared channel (PDSCH), or
a downlink control information (DCI) message on a physical downlink control channel (PDCCH).

15. The base station of claim 11, wherein the distributed precoding computation parameters comprise at least one of:
a parameter enabling/disabling distributed precoding computation,
a parameter identifying a distributed precoding computation algorithm to be used for the precoding computation scheme,
a number of iterations for the distributed precoding computation, or
a maximum iteration time for the distributed precoding computation.

16. The base station of claim 11, wherein the precoding computation scheme is determined based also on at least one of:
channel state information feedback from the plurality of UEs, or
uplink reference signals transmitted by the plurality of UEs.

17. The base station of claim 11, wherein the result of the local precoding computations comprises:
an updated result after a specific iteration of a distributed precoding computation algorithm used for the precoding computation scheme.

18. The base station of claim 11, wherein the at least one processing device is configured to determine precoders for the plurality of UEs by:
selecting a transformer-based precoding computation algorithm.

19. The base station of claim 18, wherein the at least one processing device is configured to transmit distributed precoding computation parameters by:
indicating trained neural network parameters for the transformer-based precoding computation algorithm.

20. The base station of claim 18, wherein the result of the local precoding computations comprises:
an output of a neural network encoder at each of the one or more of the plurality of UEs.
